(19) United States
(12) Patent Application Publication
(10) Pub. No.: US 2025/0026869 A1
(43) Pub. Date: Jan. 23, 2025

(54) Benzocyclobutene Resins Containing Olefinic Bonds and Preparing Methods Thereof

(71) Applicant: Wuhan Desytek Environmental Protection & New Materials Co., Ltd., Wuhan, Hubei (CN)

(72) Inventors: Yuping LEI, Wuhan, Hubei (CN); Jie Cheng, Wuhan, Hubei (CN); Ling Zou, Wuhan, Hubei (CN); Qin Wang, Wuhan, Hubei (CN); Xiaohua Tian, Wuhan, Hubei (CN); Wenyong Guo, Wuhan, Hubei (CN); Biao Lu, Wuhan, Hubei (CN)

(21) Appl. No.: 18/279,073

(22) PCT Filed: May 18, 2023
(86) PCT No.: PCT/CN2023/095136

§ 371 Date: Aug. 28, 2023

(30) Foreign Application Priority Data
Dec. 28, 2022 (CN) 202211699345.1

(51) Int. Cl. C08F 8/02

(52) U.S. Cl. CPC C08F 8/02

(57) ABSTRACT

The present invention provides benzocyclobutene resins containing olefinic bonds and preparing methods thereof, which relate to a technical field of high-performance resins. The resin structural formula of the present invention is:

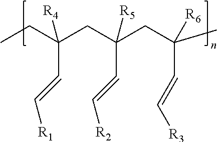

wherein R1, R2 and R3 are benzocyclobutenyls or hydrogen atoms, at least one of R1, R2 and R3 is a benzocyclobutenyl; R4, R5 and R6 are alkyls, vinyls or hydrogen atoms and are identical with each other; the preparing method thereof is to prepare the benzocyclobutene resin by reacting unsaturated resins of different molecular weights with halogenated benzocyclobutene through Heck reaction. The conditions for preparing the benzocyclobutene resin are mild and easy to produce, and the resin formed by ring-opening polymerizing and curing through further heating which has high crosslinking density, good heat resistance, good resin smoothness, and extremely low dielectric constant and dielectric loss performance, so it is a good photoelectric material.

### CROSS-REFERENCE TO RELATED APPLICATION

This application claims priority to Chinese Patent Application No. 202211699345.1, entitled “Benzocyclobutene Resins Containing Olefinic bonds and Preparing Methods Thereof” and filed on Dec. 28, 2022, in the National Intellectual Property Administration of China, the whole disclosure of which is incorporated herein by reference.

### TECHNICAL FIELD

The present invention relates to a technical field of high-performance resins, and in particular relates to benzocyclobutene resins containing olefinic bonds and preparing methods thereof.

### DESCRIPTION OF THE RELATED ART

Due to its unique non-polar four-member ring structure, benzocyclobutene can open the four-member ring under appropriate temperature conditions, and a compound itself undergoes a self-polymerization reaction, thereby forming a polymerization and curing reaction; it can also undergo Diels-Alder reaction with other olefin-containing functional groups to polymerize and cure. During the ring-opening polymerization and curing of benzocyclobutene, any small molecular compounds will not be produced, and its cured products have the advantages such as easy processing, excellent heat resistance, low thermal expansion coefficient, low moisture absorption, good flatness, good mechanical properties, extremely low dielectric constant and dielectric loss. Benzocyclobutene resins have been widely used in aerospace, microelectronic package, electrical engineering and electrical insulation, photoresist and other fields.

Benzocyclobutene is only composed of carbon and hydrogen elements, and has low dielectric constant after curing. However, benzocyclobutene is liquid at room temperature and is not easy to process. Thus, it needs to be derivatized so that other functional groups can be added. Typically, with regard to such resins, derivatives of benzocyclobutene are synthesized firstly, and then prepolymers with a certain molecular weight are formed by prepolymerizing reaction, so that the material molding process thereof can be carried out. For example, a series of CYCLOTENE Advanced Electronics Resin photoresists developed by Dow Chemical Company are prepared as follows: small molecular compounds are produced by DVS (1,3-divinyltetramethyldisiloxane) and 4-bromobenzocyclobutene through Heck reaction, and then prepolymers are obtained through prepolymerization. Therefore, the synthesis of common benzocyclobutene resins is relatively complicated, the production cost is relatively high, and it is difficult to be popularized and applied.

### SUMMARY

The purpose of the present invention is to solve the existing problems of benzocyclobutene resins, such as complex synthesis process, high production cost, and difficulty in popularization and application, and embodiments of the present invention provide benzocyclobutene resins containing olefinic bonds with excellent performance and convenient preparation and its producing method.

The first aspect of the present invention provides benzocyclobutene resins containing olefinic bonds shown in formula I.

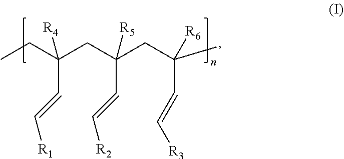

wherein R1, R2 and R3 are benzocyclobutenyls (

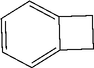

) or hydrogen atoms, at least one of R1, R2 and R3 is a benzocyclobutenyl; and R4, R5 and R6 are alkyl groups, vinyl groups or hydrogen atoms and are identical with each other.

A structural formula of the benzocyclobutenyl is as follows:

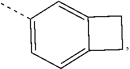

wherein a dotted line indicates a substituent position.

The polymerization degree of the benzocyclobutene resin is n, 0<n<5000, preferably 2<n<3000, and more preferably 5<n<1000.

Another aspect of the present invention provides a method for preparing benzocyclobutene resins containing olefinic bonds according to the first aspect of the present invention.

The preparing method for the resin of the formula I as provided by the present invention includes the steps of:
heating and stirring unsaturated resin, halogenated benzocyclobutene, a catalyst, a ligand, an acid-binding agent and a reaction solvent to react under a nitrogen atmosphere, and
treating the obtained reaction liquid to obtain the benzocyclobutene resins containing olefinic bonds.

The unsaturated resin of the present invention includes but not limiting to any one of 1, 2-polybutadiene and 1, 2-polyisoprene, preferably 1, 2-polybutadiene; the 1, 2-polybutadiene is isotactic 1, 2-polybutadiene or syndiotactic 1, 2-polybutadiene or a mixture of isotactic and syndiotactic 1, 2-polybutadiene, preferably the mixture of isotactic and syndiotactic 1, 2-polybutadiene wherein the content of the isotactic 1, 2-polybutadiene is larger than 50%; and an average molecular weight of the polybutadiene is 100-100000, preferably 200-50000, more preferably 500-30000.

The halogenated benzocyclobutene of the present invention is one or a mixture of 4-iodobenzocyclobutene, 4-bromobenzocyclobutene and 4-chlorobenzocyclobutene, preferably the 4-bromobenzocyclobutene; and a weight ratio of the halogenated benzocyclobutene to the unsaturated resin to be fed is (0.1˜10): 1, preferably (0.3˜5):1.

The catalyst of the present invention is palladium salt including but not limiting to one of palladium acetate, palladium chloride, Pd/C and tetra (triphenylphosphine) palladium, and a usage of the catalyst is 0.001-10.0% of the mole number of the halogenated benzocyclobutene; and the ligand is triphenylphosphine or tris (o-tolyl) phosphine, and a usage of the ligand is 1-50 times of the mole number of the catalyst.

The acid-binding agent of the present invention is an inorganic base or an organic base, including but not limiting to any one of triethylamine, n-butylamine, pyridine, potassium carbonate, sodium carbonate, sodium acetate and potassium acetate, preferably triethylamine.

The solvent of the present invention is any one of N, N-dimethylformamide, methanol, toluene, xylene, trimethylbenzene, acetonitrile, tetrahydrofuran, and 1, 4-dioxane, preferably acetonitrile.

The heating and stirring in the present invention is performed at temperature from the room temperature to 150° C., preferably from 70 to 100° C.; and the time of stirring for reaction is 3-35 hours. The treating the reaction liquid includes: adding the reaction solution into a nonpolar solvent, filtering, acid washing, washing with water to be neutral, concentrating, refining (such as column chromatography separating and purifying) it to obtain colorless or pale yellow transparent oily substance.

Compared with prior art, the advantage and beneficial effect of the present invention are obtained:
(1) The resin of the present invention is produced by reacting the unsaturated resin of known molecular weight with 4-bromobenzocyclobutene, the obtained product after treatment has a molecular weight distribution similar to that of the unsaturated resin in the raw material, and the uniformity thereof is relatively good (referring to FIG. 1), prepolymerization reaction is no longer needed, and it can directly be used for the application of next step; simultaneously, the unsaturated resin of different molecular weight in the raw material can be selected as required to produce a desired target product; Different from the resin produced with other methods, the resin produced by the present invention saves the prepolymerization reaction and greatly reduces the production cost.
(2) Laminate is made with the resin produced by the present invention, through test under the frequency of 10 GHz, it has the dielectric constant (Dk) less than 2.50, dielectric loss (Df) less than 0.001, excellent electric performance, and meets the requirements of high-speed high-frequency PCB and packaging materials.

### BRIEF DESCRIPTION OF THE DRAWINGS

FIG. 1 is a GPC detection figure of a resin according to a first embodiment of the present invention;

FIG. 2 is an IR figure of the resin according to the first to eighth embodiments of the present invention;

FIG. 3 is respectively IR figures of the resins produced in the first embodiment, a third embodiment, a fifth embodiment and a sixth embodiment of the present invention after curing;

FIG. 4 is a DSC figure of the resin of the first embodiment of the present invention;

FIG. 5 is a DSC figure of the resin produced by the first embodiment of the present invention after curing; and

FIG. 6 is an AFM image of the cured sheet in the first embodiment of the present invention.

### DETAILED DESCRIPTION OF EXEMPLARY EMBODIMENTS

The technical solutions of the present invention will be explained by the applicant in detail in conjunction with exemplary embodiments.

### First Embodiment

Benzocyclobutene resins containing olefinic bonds and preparing methods thereof are as follows:

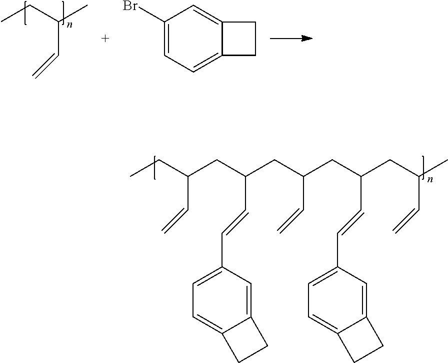

In a three-necked flask, 101.6 g (0.55 mol) of 4-bromobenzocyclobutene, 150.0 g of polybutadiene (Nippon Soda B-3000, an average molecular weight of 3200, 90% or more of 1,2-vinyl structure), 113 g (1.1 mol) of triethylamine, 1.24 g (5.5 mmol) of palladium acetate, 5.06 g (0.0167 mol) of tris (0-tolyl) phosphine, and 500 mL of acetonitrile are added in turn, heated to reflux and react under nitrogen protection for 24 h. The reaction principle thereof can be seen from the above formula. After ending the reaction, petroleum ether are added in to the product, and they are stirred, filtered, washed with water until being neutral, concentrated, and column chromatography separated and purified to obtain 191 g of light yellow transparent oil substance.

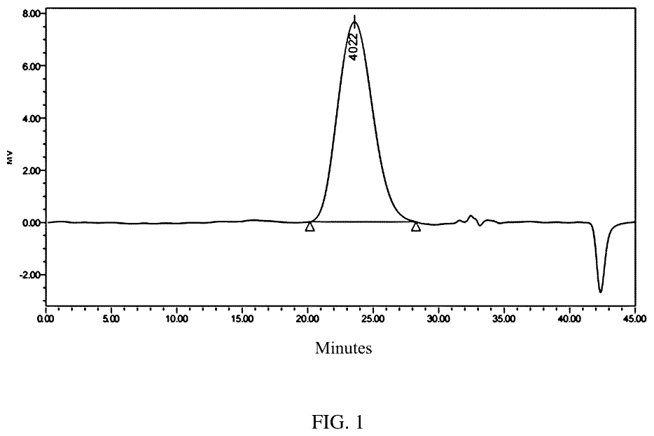

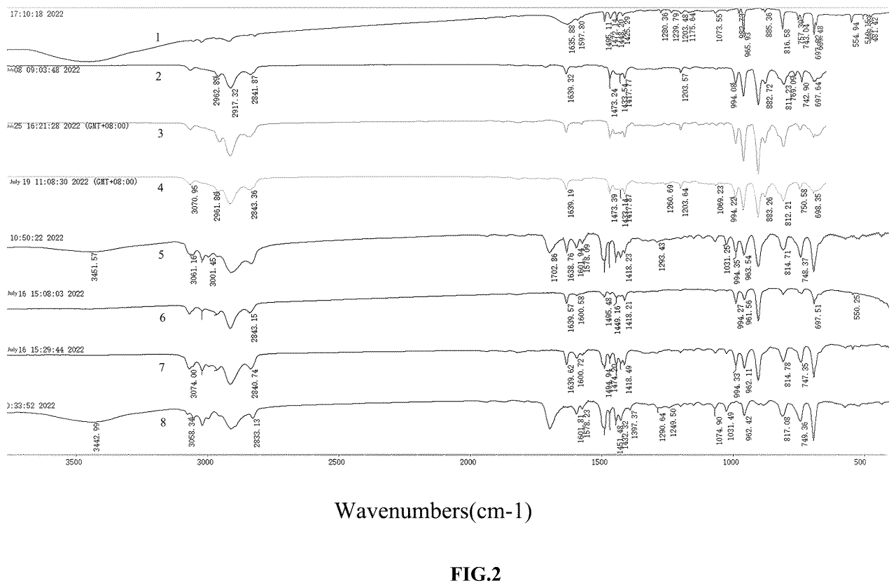

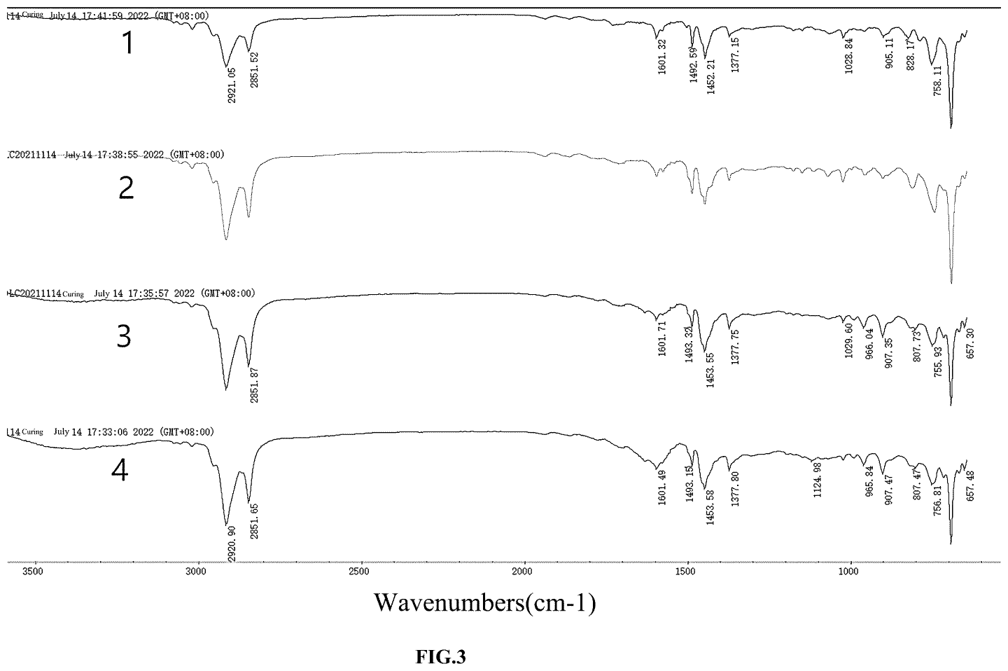

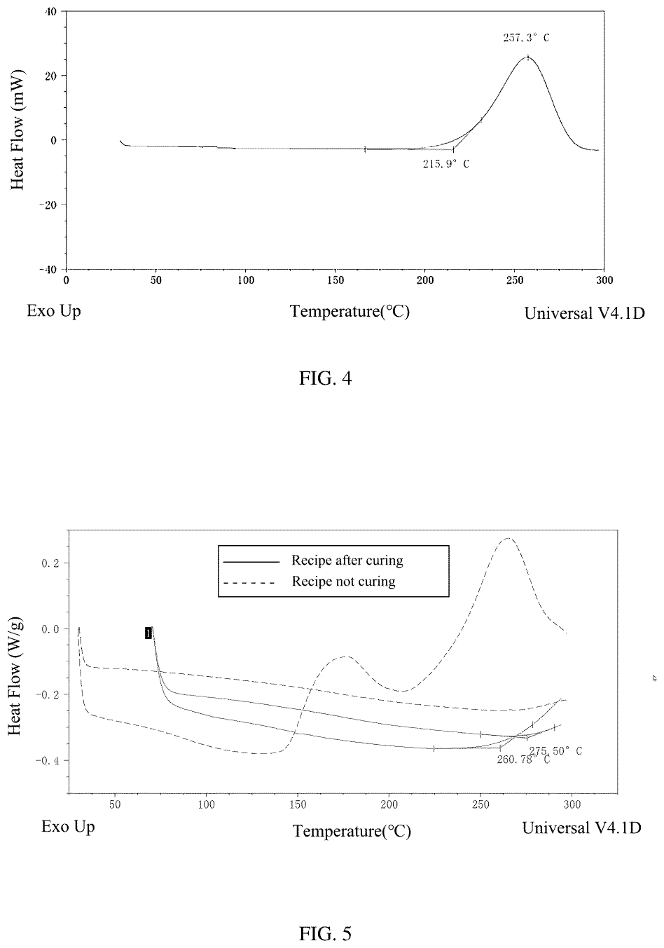

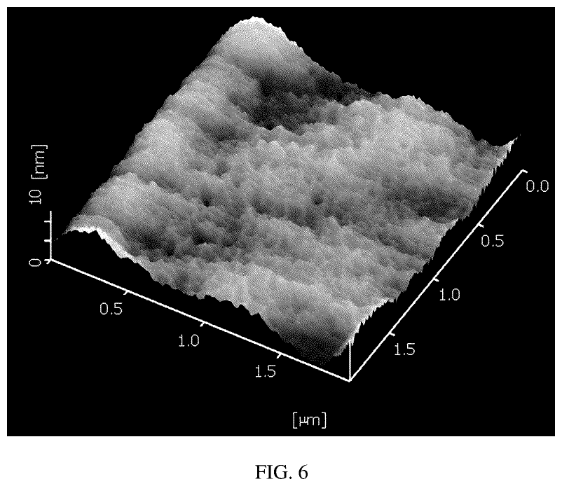

The benzocyclobutene resins containing olefinic bonds obtained in present embodiment are subjected to infrared spectroscopic analysis, and test results thereof are shown in a curve 1 of FIG. 2. It can be seen from the figure that C═C—H stretching vibration, methylene stretching vibration, methine stretching vibration and C—H stretching vibration on benzocyclobutene are respectively at 3070, 2962, 2917 and 2841 cm⁻¹, characteristic absorption peaks of benzene ring are at 1635, 1597, 1495 and 1448 cm⁻¹, indicating that the produced resin contains benzocyclobutene. An IR spectrum of the cured resin can be seen from the curve 1 of FIG. 3. It can be seen from the figure that the C═C—H stretching vibration peak at 3070 cm⁻¹ and the C—H stretching vibration peak on benzocyclobutene at 2841 cm⁻¹ disappear, indicating that both the olefinic bonds and the four rings on the benzocyclobutene participate in the reaction on curing. The benzocyclobutene resin containing olefinic bonds obtained in this embodiment is detected by GPC, referring to FIG. 1, Mp=4022; the benzocyclobutene resin containing olefinic bonds produced in this embodiment is pressed into a sheet (130*80 mm, ≤0.8 mm), the flatness thereof is very good, it is tested at a frequency of 10 GHz, and the test data is shown in Table 1 below. The glass transition temperature of the resin after being cured is >260° C., referring to FIG. 5. The AFM image of the cured sheet is shown in FIG. 6.

### Second Embodiment

Benzocyclobutene resins containing olefinic bonds and preparing methods thereof are as follows. In a three-necked flask, 152.4 g (0.83 mol) of 4-bromobenzocyclobutene, 150.0 g of polybutadiene (Nippon Soda B-3000, an average molecular weight of 3200, 90% or more of 1,2-vinyl structure), 169.5 g (1.67 mol) of triethylamine, 1.89 g (8.4 mmol) of palladium acetate, 7.72 g (0.025 mol) of tris (o-tolyl) phosphine, and 750 mL of acetonitrile are added in turn, heated to reflux and react under protection of nitrogen for 24 h. The reaction principle thereof is the same as that of the first embodiment. After ending the reaction, petroleum ether is added into the product, and they are stirred, filtered, washed with water until being neutral, concentrated, and column chromatography separated and purified to obtain 185.5 g of colorless transparent oil substance.

The benzocyclobutene resin containing olefinic bonds obtained in this embodiment is subjected to infrared spectroscopic analysis, and the detection results thereof are shown in a curve 2 of FIG. 2. The AFM image of the cured sheet obtained in this embodiment is similar to that shown in FIG. 6, and thus the image is omitted herein.

### Third Embodiment

Benzocyclobutene resins containing olefinic bonds and preparing methods thereof are as follows. In a three-necked flask, 169.3 g (0.92 mol) of 4-bromobenzocyclobutene, 150.0 g of polybutadiene (produced by Shanghai Zhenzhun Biotechnology Co., Ltd., with an average molecular weight of 5000, 20% of 1,2-vinyl structure; 30% of cis-1,4-butadiene; 50% of trans-1,4-butadiene), 255.5 g (1.85 mol) of potassium carbonate, 1.64 g (7.3 mmol) of palladium acetate, 8.44 g (0.028 mol) of tris (o-tolyl) phosphine, and 840 mL of DMF, are added in turn and heated to react at 130° C. for 12 h under the protection of nitrogen. The reaction principle is the same as that of the first embodiment above. After ending the reaction, petroleum ether was added into the product, they are stirred, filtered, washed with water until being neutral, concentrated, column chromatography separated and purified to obtain 230.0 g of light yellow transparent oil substance.

The benzocyclobutene resins containing olefinic bonds obtained in this embodiment were subjected to infrared spectrum analysis, and the test results thereof are shown in a curve 3 of FIG. 2, and an IR spectrum of the cured resin is shown in a curve 2 of FIG. 3. The AFM image of the cured sheet obtained in this embodiment is similar to that shown in FIG. 6, and thus the image is omitted herein. Compared with the polybutadiene with average molecular weight 3200 as the raw material in the first embodiment of the present invention, the IR spectrum of the resins before and after curing do not have any obvious difference. The benzocyclobutene resins containing olefinic bonds produced in this embodiment are cured and made into a sheet (130*80 mm, ≤0.8 mm), its flatness is very good, it is tested at a frequency of 10 GHz, and the test data is shown in Table 1 below. Compared with that of the first embodiment of the present invention, there is no obvious difference either. When the molecular weight of the raw material polybutadiene used in this example is obviously higher, a resin with better dielectric properties can also be obtained.

### Fourth Embodiment

Benzocyclobutene resins containing olefinic bonds and preparing methods thereof are as follows. In a three-necked flask, 507.8 g (2.77 mol) of 4-bromobenzocyclobutene, 150.0 g of polybutadiene (Shanghai Zhenzhun Biotechnology Co., Ltd., with an average molecular weight of 5000, 20% of 1,2-vinyl structure, 30% of cis-1,4-butadiene and 50% of trans-1,4-butadiene), 561.3 g (5.54 mol) of triethylamine, 4.92 g (0.022 mol) of palladium acetate, 50.6 g (0.167 mol) of tris (0-tolyl) phosphine, and 2000 mL of acetonitrile are added in turn, heated to reflux and react for 24 h under protection of nitrogen. The reaction principle is the same as that of the first embodiment above. After ending the reaction, petroleum ether was added, and they are stirred, filtered, washed with water until being neutral, concentrated, column chromatography separated and purified to obtain 550 g of light yellow transparent oil substance.

The benzocyclobutene resins containing olefinic bonds obtained in this embodiment are subjected to infrared spectroscopy analysis, and the detection results are shown in a curve 4 of FIG. 2. The AFM image of the cured sheet obtained in this embodiment is similar to that shown in FIG. 6, and thus the image is omitted herein.

### Fifth Embodiment

Benzocyclobutene resins containing olefinic bonds and preparing methods thereof are as follows:

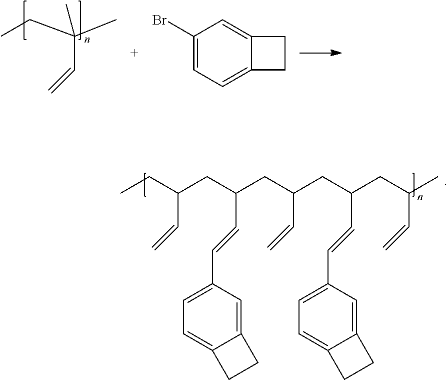

In a three-necked flask, 56.3 g (0.31 mol) of 4-bromobenzocyclobutene, 50.0 g of polyisoprene (self-made, an average molecular weight of 3000, a content of 1,2-polyisoprene >40%), 49.5 g (0.49 mol) of triethylamine, 0.55 g (2.4 mmol) of palladium acetate, 2.23 g (7.3 mmol) of tris(o-tolyl)phosphine, and 350 ml of acetonitrile, are added in turn and heated to reflux and react for 24 h under the protection of nitrogen. A reaction principle can be seen from the formula above. After ending the reaction, petroleum ether is added into the product, and they are stirred, filtered, washed with water until being neutral, concentrated, column chromatography separated and purified to obtain 65 g of light yellow transparent oil substance.

The benzocyclobutene resins containing olefinic bonds obtained in this embodiment are subjected to infrared spectroscopic analysis, and the test results thereof are shown in a curve 5 of FIG. 2. It can be seen from the figure that C═C—H stretching vibration, methyl stretching vibration, methylene stretching vibration, and C—H stretching vibration on benzocyclobutene are respectively at 3070, 2962, 2917 and 2841 cm⁻¹, the characteristic absorption peaks of benzene ring are at 1635, 1597, 1495 and 1448 cm⁻¹, indicating that the produced resin contains benzocyclobutene; an IR spectrum of the cured resin can be seen in a curve 3 of FIG. 3. It can be seen from the figure that the C═C—H stretching vibration peak at 3070 cm⁻¹ and the C—H stretching vibration peak on benzocyclobutene at 2841 cm⁻¹ disappear, indicating that both the ethylenic bonds and the four-member rings on the benzocyclobutene participate in the reaction on curing; the ethylenic bonds-containing benzocyclobutene resin produced in this embodiment is cured to make a sheet (130*80 mm, <0.8 m), which has good flatness and is tested at a frequency of 10 GHz, the test data is shown in Table 1 below.

### Sixth Embodiment

Benzocyclobutene resins containing olefinic bonds and preparing methods thereof are as follows. In a three-necked flask, 56.3 g (0.24 mol) of 4-iodobenzocyclobutene, 50.0 g of polyisoprene (self-made, an average molecular weight of 5000, a content of 1,2-polyisoprene >40%), 67.7 g (0.49 mol) of potassium carbonate, 0.55 g (2.4 mmol) of palladium acetate, 2.23 g (7.3 mmol) of tris(o-tolyl)phosphine, and 350 ml of DMF are added in turn, heated to 130° C. and reacted for 12 h under the protection of nitrogen. Reaction principle is the same as that of the fifth embodiment. After ending the reaction, petroleum ether is added, and they are stirred, filtered, washed with water until being neutral, concentrated, column chromatography separated and purified to obtain 67.7 g of light yellow transparent oil substance.

The benzocyclobutene resins containing olefinic bonds obtained in this embodiment are subjected to infrared spectroscopic analysis, and the detection results thereof are shown in a curve 6 of FIG. 2, and the IR spectrum of the cured resin is shown in a curve 4 of FIG. 3. Compared with the IR spectra of the resin of the fifth embodiment with polyisoprene having a molecular weight of 3000 as a raw material, the IR spectra of the present resin before and after curing do not have any obvious difference. The benzocyclobutene resins containing ethylenic bonds produced in this embodiment are cured to make a sheet (130*80 mm, <0.8 m), which has good flatness and is tested at a frequency of 10 GHz, the test data is shown in Table 1 below.

### Seventh Embodiment

Benzocyclobutene resins containing olefinic bonds and preparing methods thereof are as follows. In a three-necked flask, 56.3 g (0.24 mol) of 4-iodobenzocyclobutene, 50.0 g of polyisoprene (self-made, an average molecular weight of 3000, a content of 1,2-polyisoprene >40%), 49.5 g (0.49 mol) of triethylamine, 0.43 g (2.4 mmol) of palladium chloride, 2.23 g (7.3 mmol) of tris(o-tolyl)phosphine, and 350 ml of DMF are added in turn, heated to 80° C. and reacted for 16 h under the protection of nitrogen. Reaction principle is the same as that of the fifth embodiment. After ending the reaction, petroleum ether is added into the product, and they are stirred, filtered, washed with water until being neutral, concentrated, column chromatography separated and purified to obtain 60.2 g of light yellow transparent oil substance.

The benzocyclobutene resins containing olefinic bonds obtained in this embodiment are subjected to infrared spectroscopy analysis, and the detection results are shown in a curve 7 of FIG. 2.

### Eighth Embodiment

Benzocyclobutene resins containing olefinic bonds and preparing methods thereof are as follows. In a three-necked flask, 42.3 g (0.23 mol) of 4-bromobenzocyclobutene and 50.0 g of polybutadiene (self-made, an average molecular weight of 3000, a content of 1,2-polyisoprene >40%), 49.5 g (0.36 mol) of potassium carbonate, 0.52 g (2.3 mmol) of palladium acetate, 2.10 g (6.9 mmol) of tris(o-tolyl)phosphine, and 320 mL of DMF are added in turn, and heated to about 150° C. to reflux and react for 12 h under the protection of nitrogen. Reaction principle can be seen from the above-mentioned first embodiment. After ending the reaction, petroleum ether is added into the product, and they are stirred, filtered, washed with water until being neutral, concentrated, column chromatography separated and purified to obtain 58.6 g of light yellow transparent oil substance.

The benzocyclobutene resins containing olefinic bonds obtained in this embodiment are subjected to infrared spectroscopy analysis, and the detection results are shown in a curve 8 of FIG. 2.

The resin produced by the first to eighth embodiments of the present invention is cured and made into a sheet, and the flatness thereof is very good. Through being tested at a frequency of 10 GHz, it has dielectric constant (Dk) less than 2.50, the dielectric loss (Df) less than 0.001, and excellent electrical properties, while its glass transition temperature after curing also becomes higher. Compared with the current mainstream dielectric materials (see Table 1 below, for comparative examples 1-2 being ODV resin and SEBS resin respectively), it has better electrical dielectric performance and is more suitable for application in 5G and 6G high-speed and high-frequency electronic materials.

TABLE 1

| No. | Dk (10 GHz) | Df (10 GHz) | Tg (after curing) |
|---|---|---|---|
| First embodiment | 2.31 | 0.00055 | >260° C. |
| Second embodiment | 2.33 | 0.00058 | >260° C. |
| Third embodiment | 2.32 | 0.00056 | >260° C. |
| Fourth embodiment | 2.33 | 0.00052 | >260° C. |
| Fifth embodiment | 2.33 | 0.00065 | >260° C. |
| Sixth embodiment | 2.33 | 0.00063 | >260° C. |
| Seventh embodiment | 2.34 | 0.00060 | >260° C. |
| Eighth embodiment | 2.32 | 0.00052 | >260° C. |
| Comparative example 1 | 2.51 | 0.0012 | >250° C. |
| Comparative example 2 | 2.60 | 0.0015 | >250° C. |

1. A benzocyclobutene resin containing olefinic bonds, wherein the benzocyclobutene resin has a structural formula: 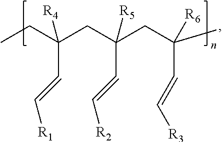
wherein R1, R2 and R3 are benzocyclobutenyls or hydrogen atoms, and at least one of R1, R2 and R3 is a benzocyclobutenyl; R4, R5 and R6 are alkyl groups, vinyl groups or hydrogen atoms and are identical with each other; 0<n<5000.

2. The resin of claim 1, wherein 0<n<1000, preferably 2<n<200, and more preferably 5<n<100.

3. A method of preparing the benzocyclobutene resin containing olefinic bonds according to claim 1, wherein the method comprising steps of:
heating and stirring unsaturated resin, halogenated benzocyclobutene, a catalyst, a ligand, an acid-binding agent and a reaction solvent to react under a nitrogen atmosphere, and treating the obtained reaction liquid to obtain the benzocyclobutene resin containing olefinic bonds.

4. The method of claim 3, wherein the unsaturated resin is an unsaturated polymer with olefinic bonds on chain segments, comprising any one of 1, 2-polybutadiene and 1, 2-polyisoprene; the 1, 2-polybutadiene is isotactic 1, 2-polybutadiene or syndiotactic 1, 2-polybutadiene or a mixture of isotactic and syndiotactic 1, 2-polybutadiene; and an average molecular weight of the unsaturated resin is 100-100000.

5. The method of claim 3, wherein the halogenated benzocyclobutene is one or a mixture of 4-iodobenzocyclobutene, 4-bromobenzocyclobutene and 4-chlorobenzocyclobutene; and a weight ratio of the halogenated benzocyclobutene to the unsaturated resin to be fed is (0.1-10): 1.

6. The method of claim 3, wherein the catalyst is palladium salt comprising one of palladium acetate, palladium chloride, Pd/C and tetra (triphenylphosphine) palladium, and a usage of the catalyst is 0.001-10.0% of a mole number of the halogenated benzocyclobutene; and the ligand is triphenylphosphine or tris (o-tolyl) phosphine, and a usage of the ligand is 1-50 times of a mole number of the catalyst.

7. The method of claim 3, wherein the acid-binding agent is an inorganic base or an organic base, comprising any one of triethylamine, pyridine, potassium carbonate, sodium carbonate, sodium acetate and potassium acetate.

8. The method of claim 3, wherein the solvent is any one of N, N-dimethylformamide, methanol, toluene, xylene, trimethylbenzene, acetonitrile, tetrahydrofuran, and 1, 4-dioxane.

9. The method of claim 3, wherein the heating and stirring is performed at a temperature from the room temperature to 150° C., preferably from 70 to 100° C.; the time of stirring for reaction is 3-35 hours.

10. The method of claim 3, wherein the treating the obtained reaction liquid comprises: adding the reaction solution into a nonpolar solvent, filtering, acid washing, washing with water to be neutral, concentrating, column chromatography separating and purifying it to obtain colorless or pale yellow transparent oily substance.

11. A method of preparing the benzocyclobutene resin containing olefinic bonds according to claim 2, wherein the method comprises steps of:
heating and stirring unsaturated resin, halogenated benzocyclobutene, a catalyst, a ligand, an acid-binding agent and a reaction solvent to react under a nitrogen atmosphere, and treating the obtained reaction liquid to obtain the benzocyclobutene resin containing olefinic bonds.
